(19) United States
(12) Patent Application Publication
(10) Pub. No.: US 2025/0310015 A1
(43) Pub. Date: Oct. 2, 2025

(54) DUAL KALMAN FILTER BASED CHANNEL PREDICTION OF UPLINK SRS MEASUREMENT

(71) Applicant: Samsung Electronics Co., Ltd., Suwon-si (KR)

(72) Inventors: Fan Zhang, Plano, TX (US); Usman Akram, Austin, TX (US); Yang Li, Plano, TX (US); Yeqing Hu, Garland, TX (US)

(21) Appl. No.: 19/011,533

(22) Filed: Jan. 6, 2025

Related U.S. Application Data
(60) Provisional application No. 63/570,167, filed on Mar. 26, 2024.

(51) Int. Cl. H04B 17/391; H04B 17/10; H04L 5/00

(52) U.S. Cl. CPC H04B 17/3913; H04B 17/104; H04L 5/0051

(57) ABSTRACT

Methods and apparatuses for dual Kalman filter (KF) based channel prediction of uplink SRS measurement in wireless communication systems. A method includes: receiving, from a user equipment (UE) via a set of antennas, channel measurement information and antenna delay values associated with the set of antennas; receiving, from the UE, an uplink sounding reference signal (SRS); applying the channel measurement information and the antenna delay values to a dual KF as an input signal; and estimating, based on the input signal to the dual KF, a set of parameters for a multipath channel model, wherein the multipath channel model is identified based on a channel response derived from the uplink SRS.

### CROSS-REFERENCE TO RELATED APPLICATIONS AND CLAIM OF PRIORITY

The present application claims priority to U.S. Provisional Patent Application No. 63/570,167, filed on Mar. 26, 2024. The contents of the above-identified patent documents are incorporated herein by reference.

### TECHNICAL FIELD

The present disclosure relates generally to wireless communication systems and, more specifically, the present disclosure relates to dual Kalman filter based channel prediction of uplink sounding reference signal (SRS) measurement in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to dual Kalman filter based channel prediction of uplink SRS measurement in wireless communication systems.

In one embodiment, a base station (BS) in a wireless communication system is provided. The BS comprises a transceiver configured to: receive, from a user equipment (UE) via a set of antennas, channel measurement information and antenna delay values associated with the set of antennas, and receive, from the UE, an uplink sounding reference signal (SRS). The BS further comprises a processor operably coupled to the transceiver, the processor configured to: apply the channel measurement information and the antenna delay values to a dual Kalman filter (KF) as an input signal, and estimate, based on the input signal to the dual KF, a set of parameters for a multipath channel model, wherein the multipath channel model is identified based on a channel response derived from the uplink SRS.

In another embodiment, a method of a BS in a wireless communication system is provided. The method comprises: receiving, from a UE via a set of antennas, channel measurement information and antenna delay values associated with the set of antennas; receiving, from the UE, an uplink SRS; applying the channel measurement information and the antenna delay values to a dual KF as an input signal; and estimating, based on the input signal to the dual KF, a set of parameters for a multipath channel model, wherein the multipath channel model is identified based on a channel response derived from the uplink SRS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7 illustrates a flowchart of a method for channel prediction according to various embodiments of the present disclosure;

FIG. 8 illustrates an example of tracking and time-domain prediction of antenna delay according to various embodiments of the present disclosure;

FIG. 9 illustrates an example of dual Kalman filter according to various embodiments of the present disclosure;

FIG. 10 illustrates an example of antenna/frequency response collected as one long vector according to various embodiments of the present disclosure;

FIG. 11 illustrates an example of antenna connected with filters according to various embodiments of the present disclosure;

FIG. 12 illustrates an example of antenna parallelly connected with filters according to various embodiments of the present disclosure;

FIG. 13 illustrates another example of antenna parallelly connected with filters according to various embodiments of the present disclosure;

FIG. 14 illustrates an example of filters connected sequentially according to various embodiments of the present disclosure; and

FIG. 15 illustrates a flowchart of a method for dual Kalman filter based channel prediction of uplink SRS measurement according to various embodiments of the present disclosure.

### DETAILED DESCRIPTION

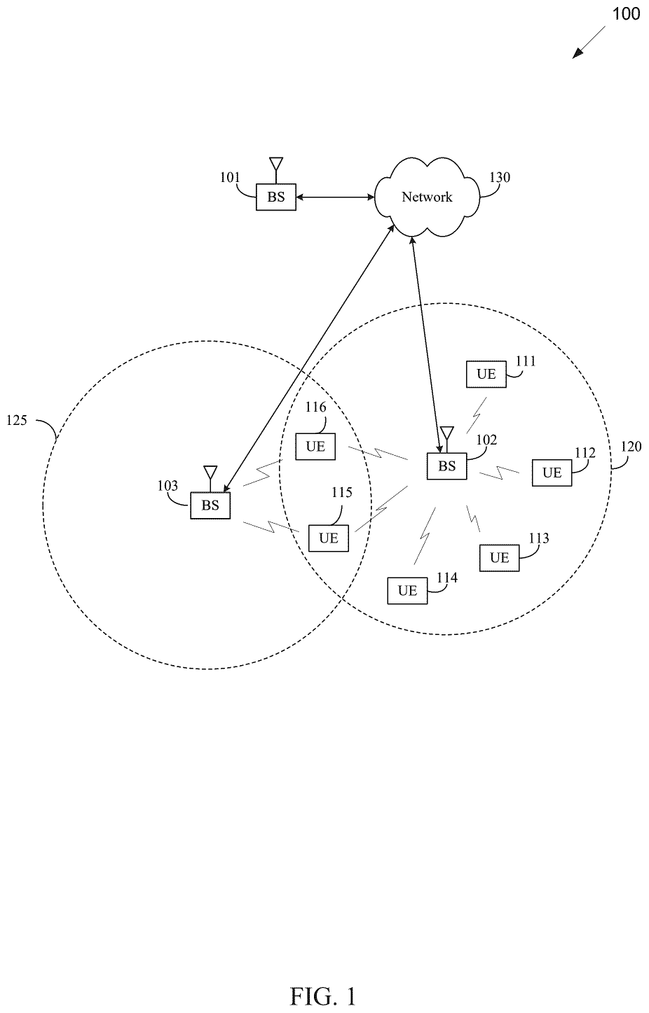

FIG. 1 through FIG. 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in the present disclosure to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in the present disclosure to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 includes circuitry, programing, or a combination thereof, to perform dual Kalman filter based channel prediction of uplink SRS measurement in wireless communication systems. Additionally, one or more of the UEs 111-116 includes circuitry, programing, or a combination thereof, for uplink SRS transmission in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

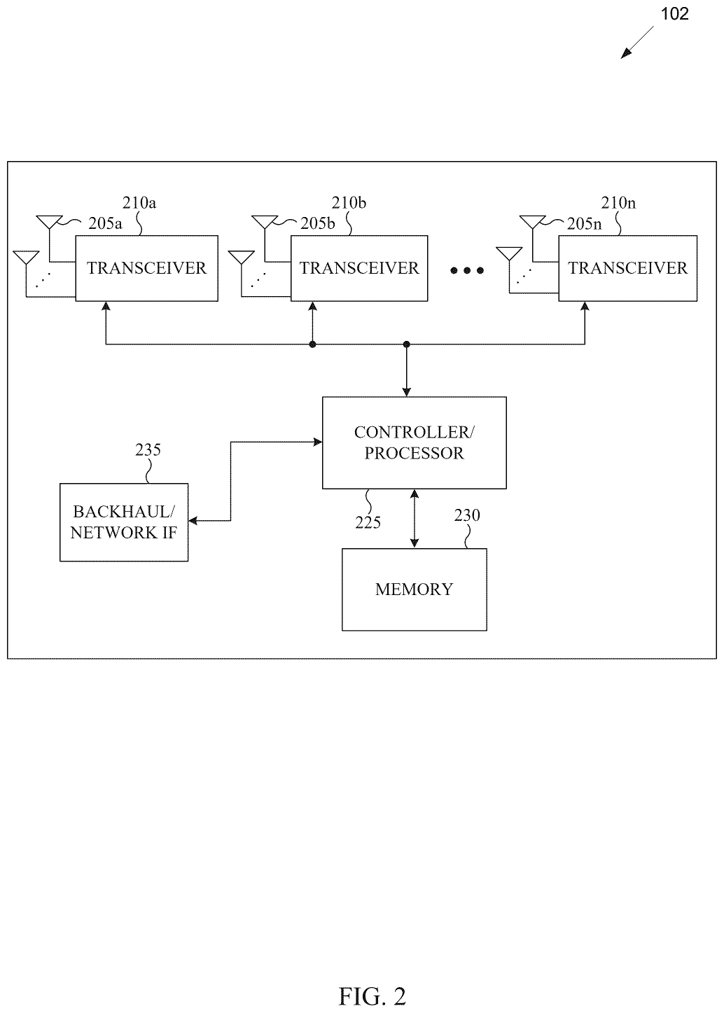

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support dual Kalman filter based channel prediction of uplink SRS measurement in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

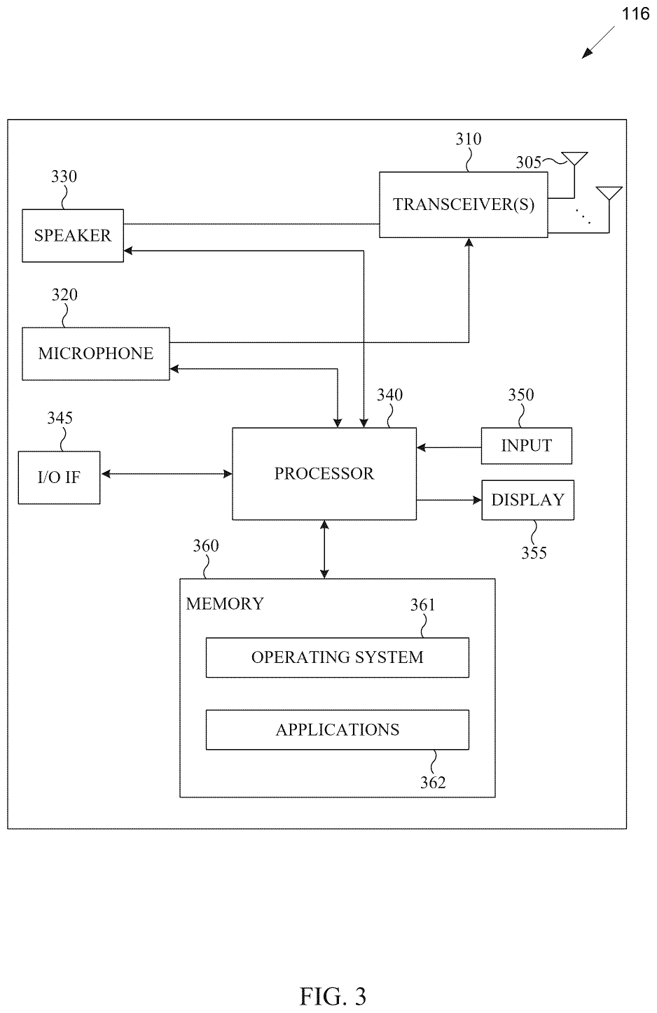

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

In various embodiments, the processor 340 may execute processes to perform reporting of CSI associated with sub-configurations in wireless communication systems as described in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

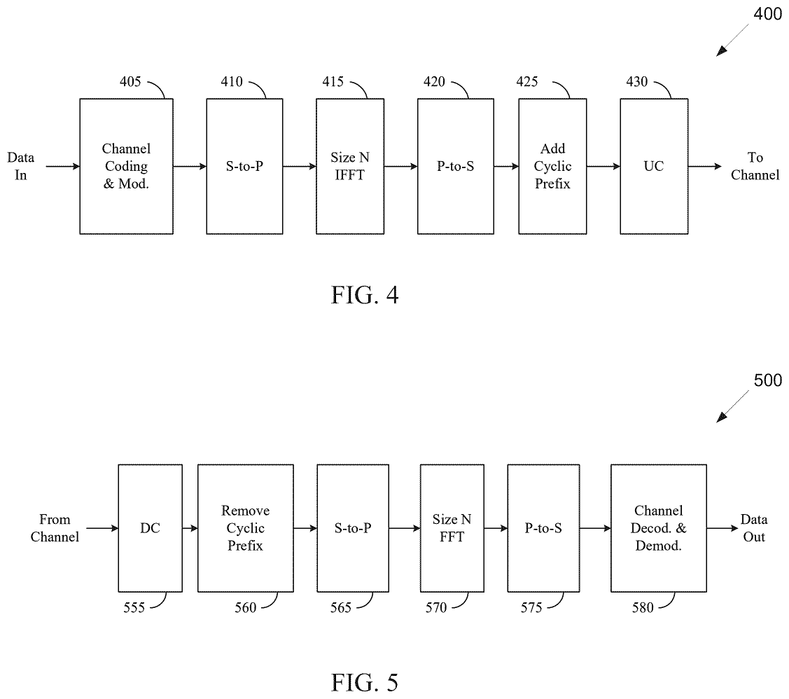

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to receive SRS transmissions in support of dual Kalman filter based channel prediction of uplink SRS measurements in wireless communication systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a downconverter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

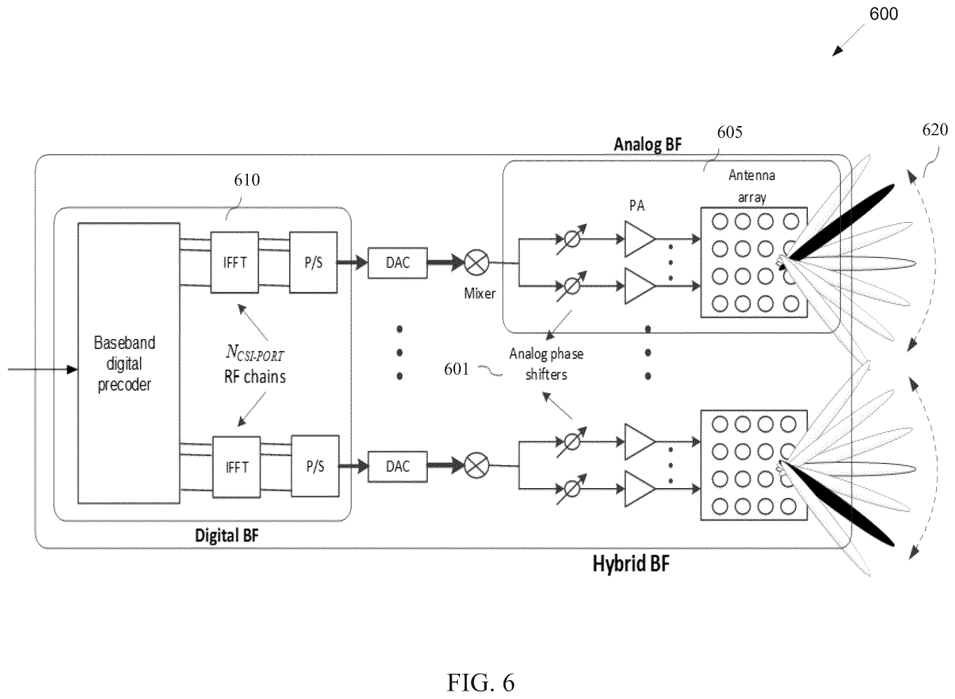

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

MIMO technologies have a key role in boosting system throughput both in NR and LTE and such a role may continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

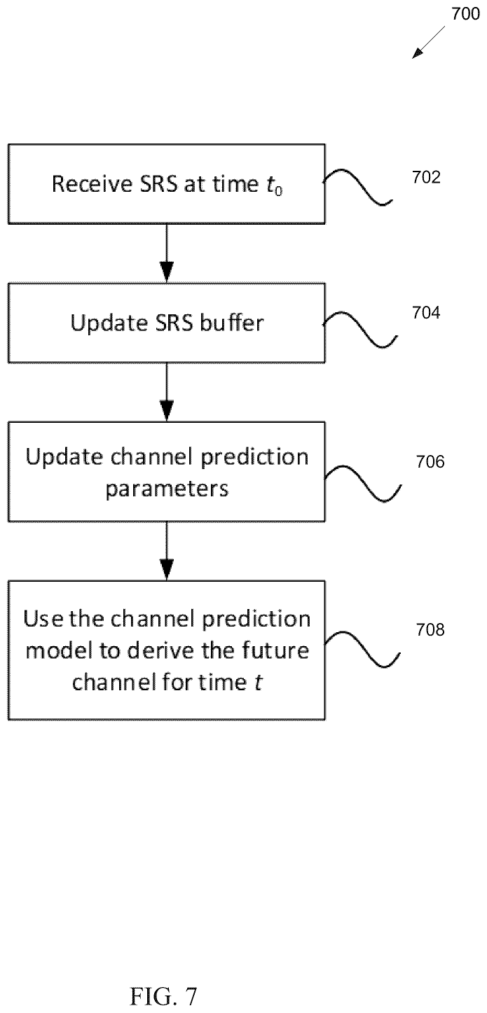

The present disclosures provides dual Kalman filter (DKF)-based channel parameter prediction algorithm for massive MIMO (mMIMO) systems. The algorithm method includes a buffer that stores past uplink SRS measurements, a parameter estimation module and a channel parameter prediction module. FIG. 7 illustrates an example channel prediction method based on the present disclosure. The accurately predicted channel can be used by other functional blocks in gNB. For example, this method helps gNB scheduler optimize resource allocation and increases the accuracy of downlink (DL) precoder and performance of DL MU-MIMO transmission.

FIG. 7 illustrates a flowchart of a method 700 for channel prediction according to various embodiments of the present disclosure. The method 700 as may be performed by a base station (e.g., 101-103 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, both parameter tracker and channel parameter prediction rely on the following multipath channel model, where the time-frequency channel response ĥ(t, fₖ) is modeled as a sum of contributions from several multipath components (MPC). The model assumes the channel is constructed on a sum of basis waveforms. In one example, P sinusoidal waveforms indexed by p=1, 2, . . . , P is used. Waveform p is parameterized by signal delays τₚ and time-varying antenna delay response γₚ(t), which spans both the time and frequency domain (if there are multiple antennas, may also span the antenna domain). Then, the channel at time t and frequency fₖ is a linear combination of the P basis waveforms:

$$h ( t , {f}_{k} ) = {\sum }_{p = 1}^{P} {γ}_{p} ( t ) {e}^{j 2 π {f}_{k} {τ}_{p}} .$$

As illustrated in FIG. 7, in step 702, the BS receives SRS at time to. In step 704, the BS updates SRS buffer. Subsequently, the BS updates channel prediction parameters. And finally, the BS in step 708 uses the channel prediction model to derive the future channel for time t.

FIG. 8 illustrates an example of tracking and time-domain prediction of antenna delay 800 according to various embodiments of the present disclosure. An embodiment of the tracking and time-domain prediction of antenna delay 800 shown in FIG. 8 is for illustration only.

In the present disclosure, the term “module” can be used to present the implementation of all or part of functions in hardware and/or software.

The present disclosure provides an algorithm of tracking and time-domain prediction module of antenna delay response γₚ(t). As illustrated in FIG. 8, the module includes two components: the filter module and prediction module.

The filter component uses a dual Kalman filter based algorithm to denoise the γₚ(t) and update the auto-regression weight w(t) of γₚ(t); the prediction component uses recursive linear prediction to generate future \hat{γ}ₚ (t+d) for channel reconstruction or other usages. The whole module also needs input of the delay values τ_{P}, which it is known in the present disclosure and in the rest of the present disclosure, figures may not include the delay input, but assume it is globally known.

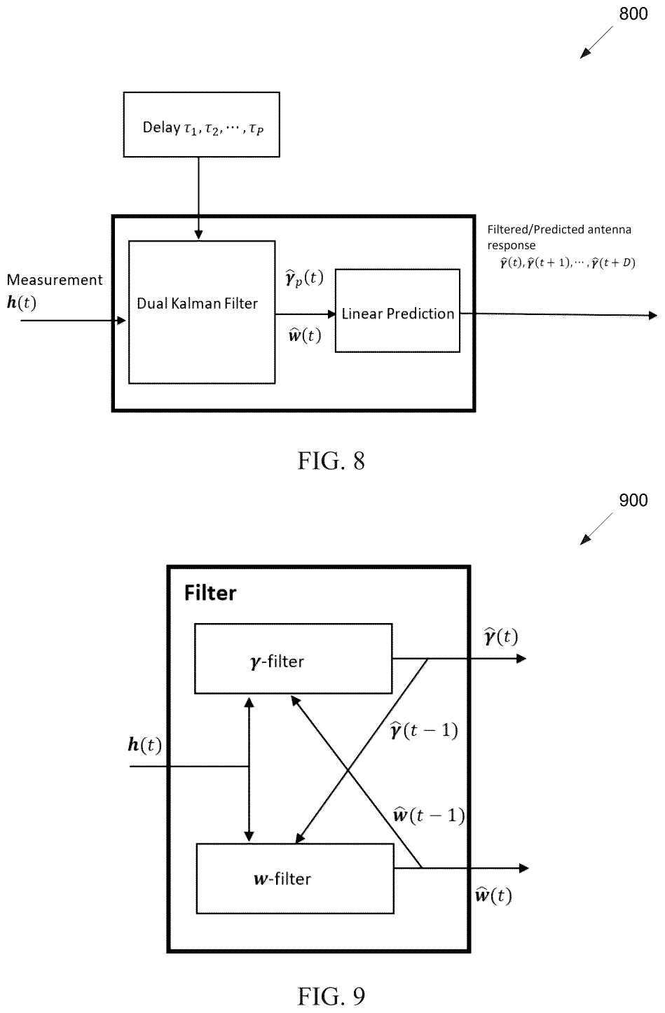

FIG. 9 illustrates an example of dual Kalman filter 900 according to various embodiments of the present disclosure. An embodiment of the dual Kalman filter 900 shown in FIG. 9 is for illustration only.

The detailed structure of the dual Kalman filter is shown in FIG. 9. The dual Kalman filter based filter component has two main parts, the antenna delay response γ-filter and the auto-regression parameter w-filter. The two parts are parallelly connected: this may pass the output (its content depends on the embodiment of w-filter) of previous time instance to each other, such that γ and w can be updated simultaneously with the updated value. The γ-filter follows the classical Kalman filter. It includes the following steps: prediction, Kalman-gain calculation and correction steps. In the present disclosure, for the w-filter, Kalman filter based and least square based filter are provided.

Decompose the signal model as follows: h(t)=B(t)γ(t), where

$$B ( t ) = [ \begin{matrix}{e}^{- j 2 π {f}_{1} {τ}_{1}} & {e}^{- j 2 π {f}_{1} {τ}_{2}} & … & {e}^{- j 2 π {f}_{1} {τ}_{p}} \\ {e}^{- j 2 π {f}_{2} {τ}_{1}} & {e}^{- j 2 π {f}_{2} {τ}_{2}} & … & {e}^{- j 2 π {f}_{2} {τ}_{2}} \\ … & … & ⋱ & ⋮ \\ {e}^{- j 2 π {f}_{M} {τ}_{1}} & {e}^{- j 2 π {f}_{M} {τ}_{2}} & … & {e}^{- j 2 π {f}_{M} {τ}_{p}}\end{matrix} ] and γ ( t ) = [ \begin{matrix}{γ}_{1} ( t ) \\ {γ}_{2} ( t ) \\ ⋮ \\ {γ}_{p} ( t )\end{matrix} ] .$$

The delay values used in the present disclosure can be time varying or time invariant. Assume the antenna delay response sequence for one path γₚ(t) follows the auto-regression (AR) model, i.e., γₚ(t) is a linear combination of the previous observation γₚ(t−l): γₚ(t)=Σₗ₌₁^{L}w_{p,i}(t)γₚ(t−l), L is the AR order.

Vectorize the current and previous L antenna delay response for one path, denote γ̅ₚ (t)=[γₚ (t), γₚ(t−1), . . . , γₚ(t−L+1)]^{T}, then it can be written:

$${\overline{γ}}_{p} ( t ) = [ \begin{matrix}{w}_{p , 1} ( t ) & … & {w}_{p , L - 1} ( t ) & {w}_{p , L} ( t ) \\ 1 & … & 0 & 0 \\ ⋮ & ⋱ & ⋮ & ⋮ \\ 0 & … & 1 & 0\end{matrix} ] {\overline{γ}}_{p} ( t - 1 ) = {W}_{p} ( t ) {\overline{γ}}_{p} ( t - 1 ) .$$

Collect antenna response of all paths into one vector γₜₒₜ:

$${γ}_{tot} ( t ) = [ \begin{matrix}{\overline{γ}}_{1} ( t ) \\ {\overline{γ}}_{2} ( t ) \\ ⋮ \\ {\overline{γ}}_{p} ( t )\end{matrix} ] = [ \begin{matrix}{W}_{1} ( t ) & 0 & … & 0 \\ 0 & {W}_{2} ( t ) & … & 0 \\ ⋮ & ⋮ & ⋱ & ⋮ \\ 0 & 0 & … & {W}_{p} ( t )\end{matrix} ] {γ}_{tot} ( t - 1 ) = {A}_{γ} ( t ) {γ}_{tot} ( t )$$

where γ-filter: the input of this part includes the measurement h(t), corrected antenna response \hat{γ}ₜₒₜ(t−1) of previous time instance, the corresponding covariance matrix P_{γ}⁺(t−1) and weight w⁺(t−1) of the previous time instance. The output is the antenna delay response of current time γₜₒₜ(t).

The filtering procedure follows the classical Kalman filter. It includes two stages: an initial stage and a tracking stage. In the initial stage, some constant parameters are generated for the tracking stage. In the tracking stage with incoming measurement, parameters are updated. Detailed steps are as shown in TABLE 1.

TABLE 1
Initial stage

| | |
|---|---|
| 1. | \hat{γ}ₜₒₜ(0) = 0, initial \hat{γ}ₜₒₜ as all-zero vectors. |
| 2. | ${P}_{γ}^{+} ( 0 ) = {η}_{1} {p}_{γ} [ \begin{matrix}{E}_{11} & 0 & 0 \\ 0 & ⋱ & 0 \\ 0 & 0 & {E}_{11}\end{matrix} ] ,$ |

E₁₁ is a L × L matrix with only the first row and column elements being
1 and the other elements are all zeros; p_{γ} is the antenna delay response
power, it can be calculated with the first input signal, or obtained from
other modules; η₁ is the scaling factor which is the ratio between the
signal power and its variance. This step to dynamically scale the
initial covariance matrix with the input signal power.

| | |
|---|---|
| 3. | R_{γ} = η₂p_{γ}I, η₂ is the scaling factor which is ratio between the signal |
| | power and noise power. |
| 4. | ${C}_{γ} = [ \begin{matrix}{e}_{1}^{T} & 0 & … & 0 \\ 0 & {e}_{1}^{T} & … & 0 \\ ⋮ & ⋮ & ⋱ & ⋮ \\ 0 & 0 & … & {e}_{1}^{T}\end{matrix} ] ,$ |
| | e₁ is a L × 1 vector with only 1 in its 1st element and all the other |
| | elements being zero. So, C_{γ} is a P × (LP) matrix. |

TABLE 2
Tracking stage

```
Prediction step:
    1. γ_{t̅ot}(t) = A_{γ}(t)\hat{γ}ₜₒₜ(t − 1)
    2. P_{γ̅}(t) = A_{γ}(t)P_{γ}⁺(t − 1)A_{γ}^{H} + Q
Kalman gain calculation step:
  3. K_{γ}(t) = P_{γ̅}(t)C_{γ}^{H}B(t)^{H}(B(t)C_{γ}P_{γ̅}(t)C_{γ}^{H}B(t)^{H} + R_{γ})⁻¹
Correction step:
  4. \hat{γ}ₜₒₜ(t) = γ_{t̅ot}(t) + Kγ(t) (h(t) − B(t)C_{γ}γ_{t̅ot}(t))
  5. P_{γ}⁺(t) = (I − K_{γ}B(t)C_{γ})P_{γ̅}
w-filter: The input of this part includes the measurement h(t), corrected weight ŵ(t − 1), the
corresponding covariance matrix P_{w}⁺(t − 1) and antenna delay response \hat{γ}ₜₒₜ(t − 1) of the
previous time. The output is the updated weight of current time ŵ(t). Below are 2 embodiments:
```

In one embodiment, for Kalman filter, following steps are provided.

TABLE 3
Steps for Kalman filter

```
Initial stage:
$1. \hat{w} ( 0 ) = {[ {e}_{1}^{T} , {e}_{1}^{T} , ⋯ , {e}_{1}^{T} ]}^{T} , initialized as a vector of dimension LP .$
$2. {P}_{w}^{+} ( 0 ) = I , Initialized as an identity matrix .$
Tracking stage:
Prediction step:
      1. w⁻(t) = ŵ(t − 1)
  $2. {P}_{w}^{-} ( t ) = {λ}^{- 1} {P}_{w}^{+} ( t - 1 ) , λ is the forgetting factor , can be configured according to the$
channel quality, typical value is 0.9.
Kalman gain calculation step:
        $3. {A}_{w} ( t ) = \frac{\partial {γ}_{tot}^{-} ( t )}{\partial w} [ \begin{matrix}{Γ}_{1} ( t - 1 ) & 0 & … & 0 \\ 0 & {Γ}_{2} ( t - 1 ) & … & 0 \\ ⋮ & ⋮ & ⋱ & ⋮ \\ 0 & 0 & … & {Γ}_{P} ( t - 1 )\end{matrix} ] ,$
        $Where {Γ}_{p} ( t - 1 ) = [ \begin{matrix}{\overline{γ} ( t - 1 )}^{T} \\ {0}_{( L - 1 ) \times L}\end{matrix} ] .$
        $\\ \begin{matrix}4. & {K}_{w} ( t ) = {P}_{w}^{-} ( t ) {A}_{w}^{H} ( t ) {C}^{H} {B ( t )}^{H} ( B ( t ) {CA}_{w} ( t ) {P}_{w}^{-} {A}_{w}^{H} ( t ) {C}^{H} {B ( t )}^{H} +\end{matrix}$
${B ( t ) {CQC}^{H} B ( t ) )}^{- 1} ,$
Correction step:
        $\hat{w} ( t ) = {w}^{-} ( t ) + {K}_{w} ( t ) ( h ( t ) - BC {γ}_{tot}^{-} ( t ) )$
        ${P}_{w}^{+} ( t ) = ( 1 - {K}_{w} ( t ) B ( t ) {CA}_{w} ) {P}_{w}^{-}$
```

In one embodiment, for least square filter, following steps are provided. In this embodiment, the weight w and measurement h are viewed as a linear combination. The detailed update algorithm is shown below (may use same notation in embodiment 2 Kalman filter):

TABLE 4
Steps for least square filter

```
Cross-correlation/auto-correlation calculation:
  IF t = 1
    C_{ww}(t) = (B(t)CA_{w}(t))^{H}(B(t)CA_{w}(t))
    c_{wh}(t) = (B(t)CA_{w}(t))^{H}h(t)
  ELSE
    C_{ww}(t) = λC_{ww}(t − 1) + (1 −
λ) (B(t)CA_{w}(t))^{H}(B(t)CA_{w}(t))
    c_{wh}(t) = λc_{wh}(t) + (1 − λ)(B(t)CA_{w}(t))^{H}h(t)
Weight calculation:
w(t) = C_{ww}⁻¹(t)c_{wh}(t),
```

Due to the channel processing delay, beamforming delay, etc., the prediction depth (D) may be different over different scenarios. Sometimes more than 1-step prediction is needed. Under this scenario, the present disclosure provides a recursive way to do the prediction: first process the 1-step prediction using the updated weight and the latest L antenna responses in the buffer. Then use the 1-step prediction and latest (L−1) antenna response, total L samples to generate 2-step prediction. Repeat this procedure until obtaining required D predictions.

The input of this component includes the filtered antenna delay response \hat{γ}ₚ (t), the component has one buffer to store the history of \hat{γ}ₚ(t) and the updated weight ŵₚ(t). The pseudo-code is below as shown in TABLE 5.

TABLE 5
Pseudo-code

FOR p = 1:P
FOR d = 1: D
\hat{γ}ₚ(t + d) = Σ_{1≤l≤L} w_{l,p}(\hat{γ}ₚ(t + d + l − 2)
END
END
Note that for a time instance t₀ , when t ≤ t₀ , \hat{γ}(t) is obtained from the γ -filter (from
history/buffer); when t > t₀, \hat{γ}(t) is generated via this recursive prediction.

Depending on the processing capability, processing delay requirements, channel condition (especially on antenna spatial correlation), a dual Kalman filter (DKF) can be deployed via different connections over the multiple antennas in gNB. Denote the number of antennas at gNB as M, use hₘ(t) to represent the measurement at antenna m. The following are 4 connection options: 1. Joint; 2. Sequential; 3. Parallel; 4. Hybrid.

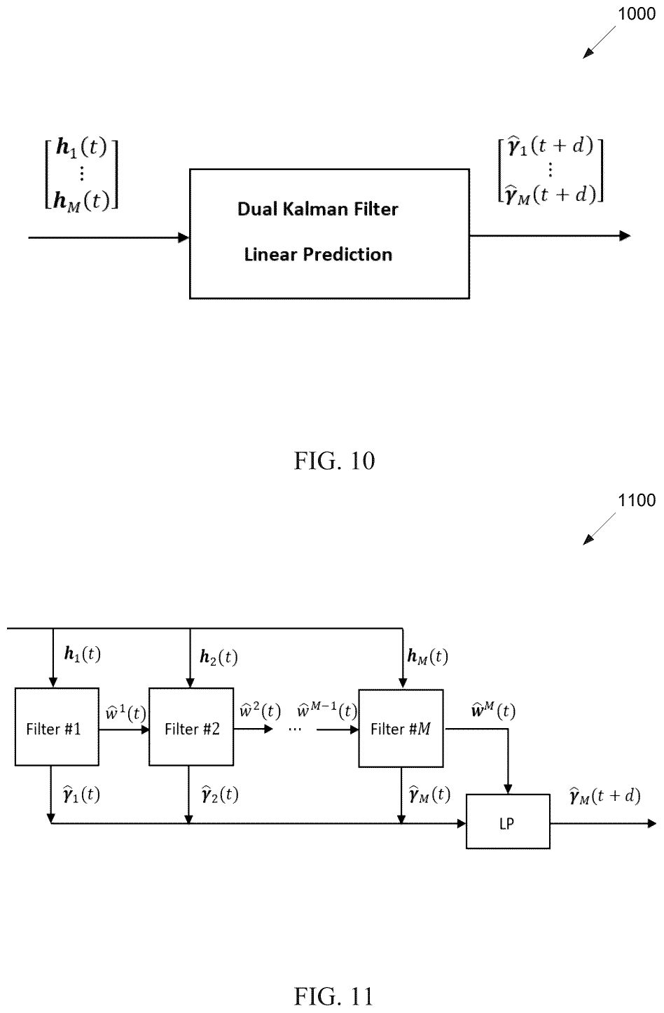

In one embodiment, a joint option is provided. In such joint option, all the antenna/frequency response is collected as one long vector as shown in FIG. 10. The dual Kalman filter (KF) is processed directly on this long vector.

FIG. 10 illustrates an example of antenna/frequency response collected as one long vector 10000 according to various embodiments of the present disclosure. An embodiment of the antenna/frequency response collected as one long vector 10000 shown in FIG. 10 is for illustration only.

This embodiment theoretically provides the optimal performance, but as it vectorizes all the antenna delay response into one large vector, the complexity of this embodiment may be extremely high (mainly due to large dimension matrix inversion and multiplication). The following embodiments aims at reducing the complexity without losing too much performance.

In one embodiment, a sequential option is provided. In such embodiment, the filter for each antenna is connected with some order as shown in FIG. 11. This order can be time varying or time invariant. And it can be generated through the SNR, received power etc. The algorithm in the present disclosure does not depend on the order. In this sequential connected structure, the weight used for one antenna is the updated weight of the previous antenna. The linear prediction module uses the weight updated by the last antenna.

FIG. 11 illustrates an example of antenna connected with filters 1100 according to various embodiments of the present disclosure. An embodiment of the antenna connected with filters 1100 shown in FIG. 11 is for illustration only.

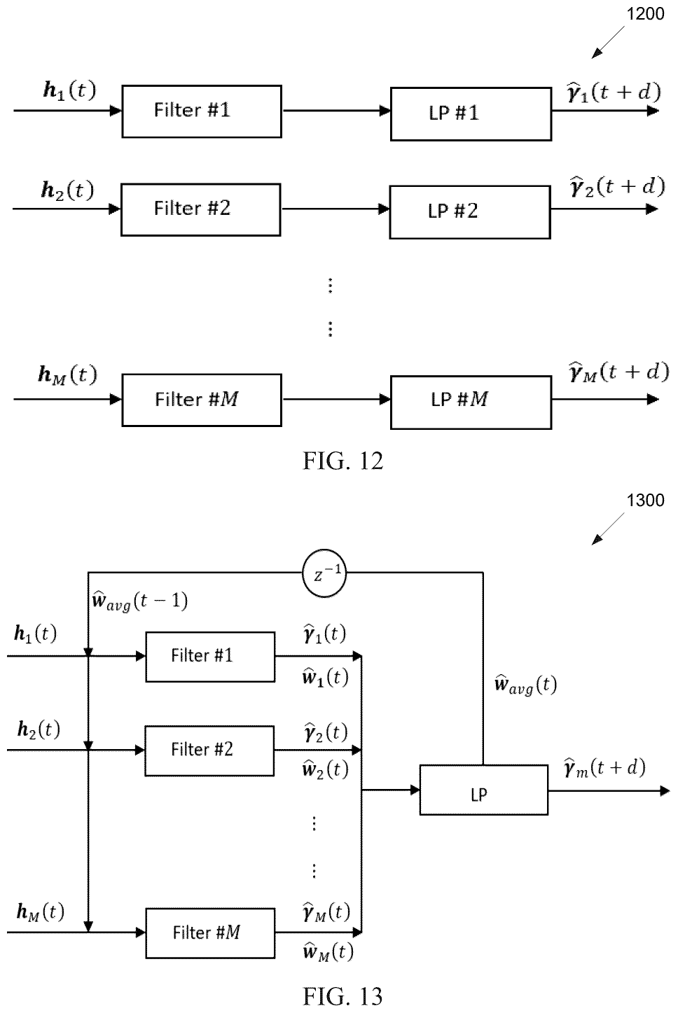

In one embodiment, a parallel option is provided. In such embodiment, the filter for each antenna is connected parallelly as shown in FIG. 12. Under this parallel connection, the antennas can process totally independently or first process independently, then the weight output are averaged over antennas, which means the weight input of each antenna may be the same.

FIG. 12 illustrates an example of antenna parallelly connected with filters 1200 according to various embodiments of the present disclosure. An embodiment of the antenna parallelly connected with filters 1200 shown in FIG. 12 is for illustration only.

In one embodiment, a hybrid option is provided. In such embodiment, the filter for each antenna is connected parallelly and may process independently as shown in FIG. 13. The difference compared with embodiment 3 parallel is that after the independent process of each antenna, the LP module may collect the outputs of all antennas and generate one weight vector for prediction and as the previous weight value for all antennas in the next process time. One method for calculating the weight ŵ_{avg}(t) is weighted sum: ŵ_{avg}(t)=Σ_{1≤m≤M}αₘŵₘ(t), with Σ_{1≤m≤M}αₘ=1.

FIG. 13 illustrates another example of antenna parallelly connected with filters 1300 according to various embodiments of the present disclosure. An embodiment of the antenna parallelly connected with filters 1300 shown in FIG. 13 is for illustration only.

The weight can be chosen according to the power of delay response or the weight can use simply arithmetic average.

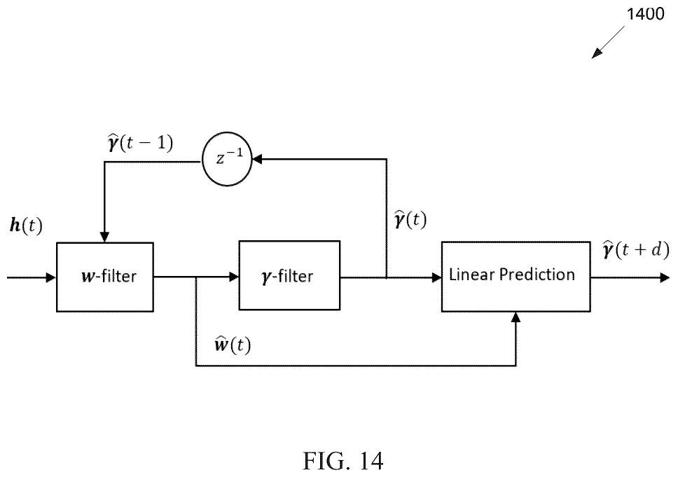

In another embodiment of filter component for the present disclosure, the γ-filter and w-filter are connected sequentially as shown in FIG. 14. Under this implementation, either γ-filter or w-filter can be first processed. Below is one example flow chart, when w is first processed.

FIG. 14 illustrates an example of filters connected sequentially 1400 according to various embodiments of the present disclosure. An embodiment of the filters connected sequentially 1400 shown in FIG. 14 is for illustration only.

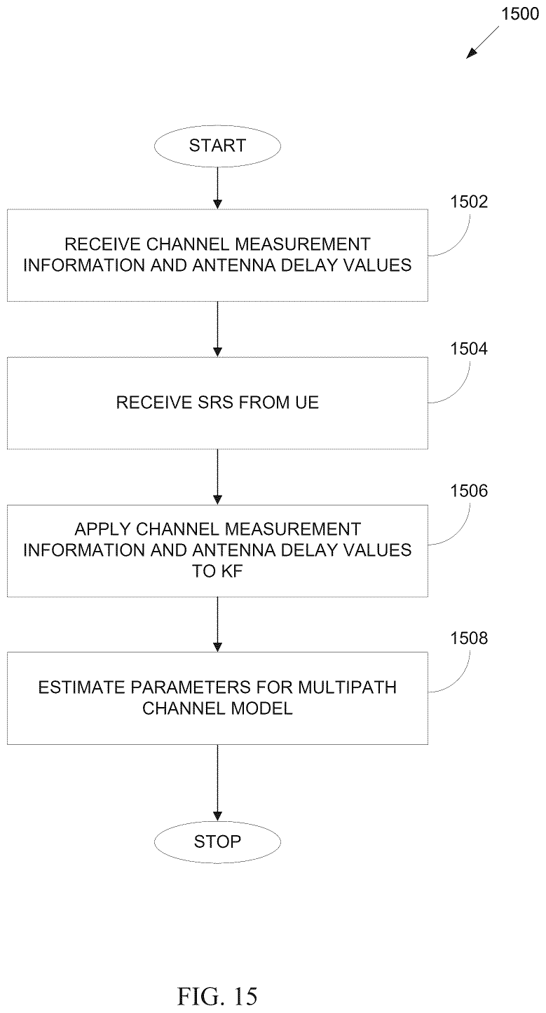

FIG. 15 illustrates a flowchart of a method for dual Kalman filter based channel prediction of uplink SRS measurement according to various embodiments of the present disclosure. The method 1500 as may be performed by a base station (e.g., 101-103 as illustrated in FIG. 1). An embodiment of the method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

As illustrated in FIG. 15, in step 1502, the BS receives, from a UE via a set of antennas, channel measurement information and antenna delay values associated with the set of antennas.

Subsequently, in step 1504, the BS receives, from the UE, an uplink SRS.

Next, in step 1506, the BS applies the channel measurement information and the antenna delay values to a dual KF as an input signal.

In one embodiment, the dual KF comprises a gamma (γ) filter and a weight (w) filter. In such embodiment, the γ filter uses fixed parameters to predict a channel and sends a gamma estimation to the w filter and the γ filter and the w filter are configured to be connected in a serial manner or a parallel manner.

In one embodiment, the γ filter comprises a KF and the w filter comprises the KF or a filter using a least square algorithm to calculate a cross-correlation value and an auto-correlation value between a weight and a result of channel measurement corresponding to each of the set of antennas or the γ filter comprises a KF and the w filter comprises the KF or a filter using a least square algorithm to calculate a weight of each of the set of antennas.

Finally, in step 1508, the BS estimates, based on the input signal to the dual KF, a set of parameters for a multipath channel model, wherein the multipath channel model is identified based on a channel response derived from the uplink SRS.

In one embodiment, the BS identifies, via the dual KF, an antenna delay response and an autoregression weight of the antenna delay response and performs, based on the antenna delay response and the autoregression weight, a linear prediction operation using a recursive algorithm.

In one embodiment, the BS enables a recursive algorithm to obtain a 1-step prediction using an updated weight and a first latest antenna response comprising a number of L samples.

In one embodiment, the BS generates a 2-step prediction based on the 1-step prediction and a second latest antenna response comprising a number of (L−1) samples.

In one embodiment, the BS vectorizes, based on a linear prediction operation, antenna delay responses into a single vector.

In one embodiment, the BS sequentially identifies, based on a previous weight of each of the set of antennas, a weight used for each of the set of antennas and updates, based on a linear prediction operation, the weight that is lastly used at an antenna in the set of antennas.

In such embodiments, the set of antennas includes a set of filters each of which is connected each other in a sequential order in a time-varying operation or in a time-unvarying operation, each antenna including a filter in the set of filters.

In one embodiment, the BS identifies a weight of each of the set of antennas in a parallel manner and updates the weight of each of the set of antennas simultaneously after a filtering operation and a linear prediction operation.

In such embodiment, the set of antennas includes the set of filters each of which is connected each other in a parallel manner, each antenna including a filter in the set of filters.

In one embodiment, the BS collects, based on a linear prediction operation, output signals of entire antennas in the set of antennas and generates, based on the output signals, a weight vector for predicting the uplink SRS.

In such embodiment, a previous weight value for the entire antennas in the set of antennas is used to collect the output signals of the entire antennas in the set of antennas.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to:
receive, from a user equipment (UE) via a set of antennas, channel measurement information and antenna delay values associated with the set of antennas, and
receive, from the UE, an uplink sounding reference signal (SRS); and
a processor operably coupled to the transceiver, the processor configured to:
apply the channel measurement information and the antenna delay values to a dual Kalman filter (KF) as an input signal, and
estimate, based on the input signal to the dual KF, a set of parameters for a multipath channel model, wherein the multipath channel model is identified based on a channel response derived from the uplink SRS.

2. The BS of claim 1, wherein the processor is further configured to:
identify, via the dual KF, an antenna delay response and an autoregression weight of the antenna delay response; and
perform, based on the antenna delay response and the autoregression weight, a linear prediction operation using a recursive algorithm.

3. The BS of claim 1, wherein:
the dual KF comprises a gamma (γ) filter and a weight (w) filter;
the γ filter uses fixed parameters to predict a channel and sends a gamma estimation to the w filter; and
the γ filter and the w filter are configured to be connected in a serial manner or a parallel manner.

4. The BS of claim 3, wherein:
the γ filter comprises a KF and the w filter comprises the KF or a filter using a least square algorithm to calculate a cross-correlation value and an auto-correlation value between a weight and a result of channel measurement corresponding to each of the set of antennas; or
the γ filter comprises a KF and the w filter comprises the KF or a filter using a least square algorithm to calculate a weight of each of the set of antennas.

5. The BS of claim 1, wherein the processor is further configured to enable a recursive algorithm to obtain a 1-step prediction using an updated weight and a first latest antenna response comprising a number of L samples.

6. The BS of claim 5, wherein the processor is further configured to generate a 2-step prediction based on the 1-step prediction and a second latest antenna response comprising a number of (L−1) samples.

7. The BS of claim 1, wherein the processor is further configured to vectorize, based on a linear prediction operation, antenna delay responses into a single vector.

8. The BS of claim 1, wherein:
the processor is further configured to:
sequentially identify, based on a previous weight of each of the set of antennas, a weight used for each of the set of antennas, and
update, based on a linear prediction operation, the weight that is lastly used at an antenna in the set of antennas; and
the set of antennas includes a set of filters each of which is connected each other in a sequential order in a time-varying operation or in a time-unvarying operation, each antenna including a filter in the set of filters.

9. The BS of claim 1, wherein:
the processor is further configured to:
identify a weight of each of the set of antennas in a parallel manner, and
update the weight of each of the set of antennas simultaneously after a filtering operation and a linear prediction operation; and
the set of antennas includes the set of filters each of which is connected each other in a parallel manner, each antenna including a filter in the set of filters.

10. The BS of claim 1, wherein:
the processor is further configured to:
collect, based on a linear prediction operation, output signals of entire antennas in the set of antennas, and
generate, based on the output signals, a weight vector for predicting the uplink SRS; and
a previous weight value for the entire antennas in the set of antennas is used to collect the output signals of the entire antennas in the set of antennas.

11. A method of a base station (BS) in a wireless communication system, the method comprising:
receiving, from a user equipment (UE) via a set of antennas, channel measurement information and antenna delay values associated with the set of antennas;
receiving, from the UE, an uplink sounding reference signal (SRS);
applying the channel measurement information and the antenna delay values to a dual Kalman filter (KF) as an input signal; and
estimating, based on the input signal to the dual KF, a set of parameters for a multipath channel model, wherein the multipath channel model is identified based on a channel response derived from the uplink SRS.

12. The method of claim 11, further comprising:
identifying, via the dual KF, an antenna delay response and an autoregression weight of the antenna delay response; and
performing, based on the antenna delay response and the autoregression weight, a linear prediction operation using a recursive algorithm.

13. The method of claim 11, wherein:
the dual KF comprises a gamma (γ) filter and a weight (w) filter;
the γ filter uses fixed parameters to predict a channel and sends a gamma estimation to the w filter; and
the γ filter and the w filter are configured to be connected in a serial manner or a parallel manner.

14. The method of claim 13, wherein:
the γ filter comprises a KF and the w filter comprises the KF or a filter using a least square algorithm to calculate a cross-correlation value and an auto-correlation value between a weight and a result of channel measurement corresponding to each of the set of antennas; or
the γ filter comprises a KF and the w filter comprises the KF or a filter using a least square algorithm to calculate a weight of each of the set of antennas.

15. The method of claim 11, further comprising enabling a recursive algorithm to obtain a 1-step prediction using an updated weight and a first latest antenna response comprising a number of L samples.

16. The method of claim 15, further comprising generating a 2-step prediction based on the 1-step prediction and a second latest antenna response comprising a number of (L−1) samples.

17. The method of claim 11, further comprising vectorizing, based on a linear prediction operation, antenna delay responses into a single vector.

18. The method of claim 11, further comprising:
sequentially identifying, based on a previous weight of each of the set of antennas, a weight used for each of the set of antennas; and
updating, based on a linear prediction operation, the weight that is lastly used at an antenna in the set of antennas,
wherein the set of antennas includes a set of filters each of which is connected each other in a sequential order in a time-varying operation or in a time-unvarying operation, each antenna including a filter in the set of filters.

19. The method of claim 11, further comprising:
identifying a weight of each of the set of antennas in a parallel manner; and
updating the weight of each of the set of antennas simultaneously after a filtering operation and a linear prediction operation,
wherein the set of antennas includes the set of filters each of which is connected each other in a parallel manner, each antenna including a filter in the set of filters.

20. The method of claim 11, further comprising:
collecting, based on a linear prediction operation, output signals of entire antennas in the set of antennas; and
generating, based on the output signals, a weight vector for predicting the uplink SRS,
wherein a previous weight value for the entire antennas in the set of antennas is used to collect the output signals of the entire antennas in the set of antennas.
